(19) United States
(12) Patent Application Publication
(10) Pub. No.: US 2019/0147383 A1
(43) Pub. Date: May 16, 2019

(54) COLLABORATION AND MEETING ANNOTATION

(71) Applicant: Colossio, Inc., Chicago, IL (US)

(72) Inventor: Joseph A. Jaroch, Chicago, IL (US)

(21) Appl. No.: 15/809,226

(22) Filed: Nov. 10, 2017

(51) Int. Cl. G06Q 10/06; G06Q 10/10

(52) U.S. Cl. CPC G06Q 10/06393; H04L 67/10; G06Q 10/109

(57) ABSTRACT

Various aspects of the subject technology relate to a system that may include receiving contents of a correspondence, the contents comprising at least one of audio data, text data, and presentation data. A textual format of the contents is generated. Terms included in the textual format of the contents are associated with participants of the correspondence and timestamps. An engagement rate of each of the participants is determined based on associating the terms with the participants and the timestamps. Frequencies of occurrences for the terms included in the textual format of the contents are determined. A focus point of the correspondence is identified based on the determined frequencies of occurrences for the terms. A summary of the correspondence that includes the focus point of the correspondence, the engagement rate for each of the participants of the correspondence, and a time duration over which the correspondence occurs is provided for display.

### BACKGROUND

### Field

The present disclosure generally relates to visualization and annotation of the contents of meetings.

### Description of the Related Art

Meetings are a necessary part of businesses and allow for numerous people to share and collaborate toward solving a common problem. Taking notes and summarizing the contents of meetings may be an inefficient use of time and allows for the introduction of personal bias, as the note taker may choose to exclude some information from the record or may have inaccurately recorded. Additionally, dissemination of the notes often takes place only in a summarized form, preventing deeper context from being shared to those who were not in the meeting.

### SUMMARY

The subject technology includes receiving contents of a correspondence, the contents comprising at least one of audio data, text data, and presentation data. A textual format of the contents is generated. Terms included in the textual format of the contents are associated with participants of the correspondence and timestamps. An engagement rate of each of the participants is determined based on associating the terms with the participants and the timestamps. Frequencies of occurrences for the terms included in the textual format of the contents are determined. A focus point of the correspondence is identified based on the determined frequencies of occurrences for the terms. A summary of the correspondence that includes the focus point of the correspondence, the engagement rate for each of the participants of the correspondence, and a time duration over which the correspondence occur is provided for display.

According to one embodiment of the present disclosure, a computer-implemented method is provided for automated quantitative assessment of text complexity. The method includes receiving contents of a correspondence, the contents comprising at least one of audio data, text data, and presentation data. A textual format of the contents is generated. Terms included in the textual format of the contents are associated with participants of the correspondence and timestamps. An engagement rate of each of the participants is determined based on associating the terms with the participants and the timestamps. Frequencies of occurrences for the terms included in the textual format of the contents are determined. A focus point of the correspondence is identified based on the determined frequencies of occurrences for the terms. A summary of the correspondence that includes the focus point of the correspondence, the engagement rate for each of the participants of the correspondence, and a time duration during which the correspondence occurs.

According to one embodiment of the present disclosure, a non-transitory computer readable storage medium is provided including instructions that, when executed by one or more processors, cause the one or more processors to receive contents of a correspondence, the contents comprising at least one of audio data, text data, and presentation data. A textual format of the contents is generated. Terms included in the textual format of the contents are associated with participants of the correspondence and timestamps. An engagement rate of each of the participants is determined based on associating the terms with the participants and the timestamps. Frequencies of occurrences for the terms included in the textual format of the contents are determined. A focus point of the correspondence is identified based on the determined frequencies of occurrences for the terms. A summary of the correspondence that includes the focus point of the correspondence, the engagement rate for each of the participants of the correspondence, and a time duration over which the correspondence occur is provided for display.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the images and detailed description are to be regarded as illustrative in nature and not as restrictive.

### BRIEF DESCRIPTION OF THE IMAGES

The accompanying images, which are included to provide further understanding and are incorporated in and constitute a part of this specification, illustrate disclosed embodiments and together with the description serve to explain the principles of the disclosed embodiments. In the images:

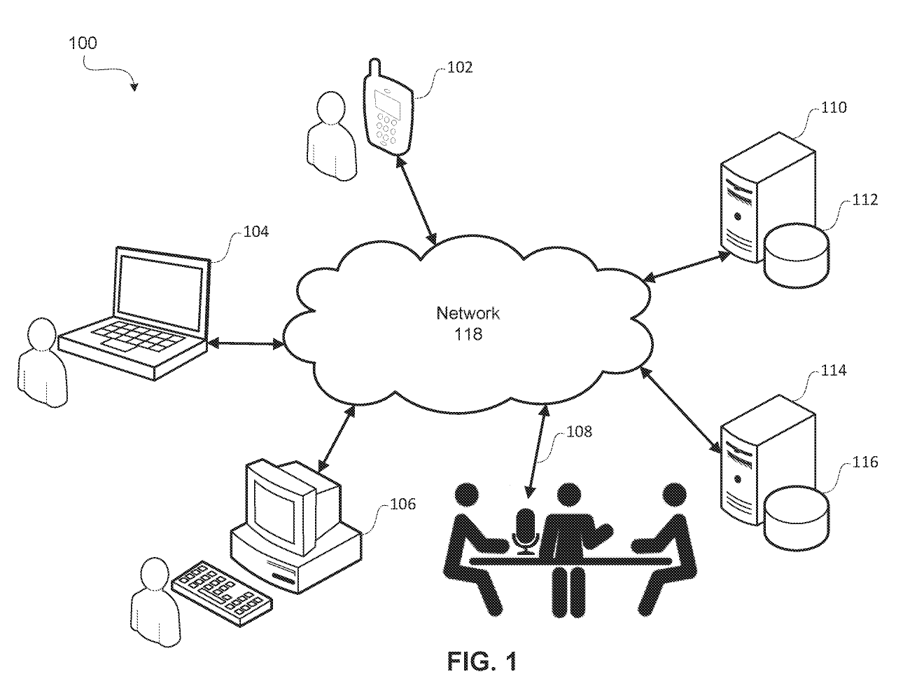

FIG. 1 illustrates an example network environment according to example aspects of the subject technology.

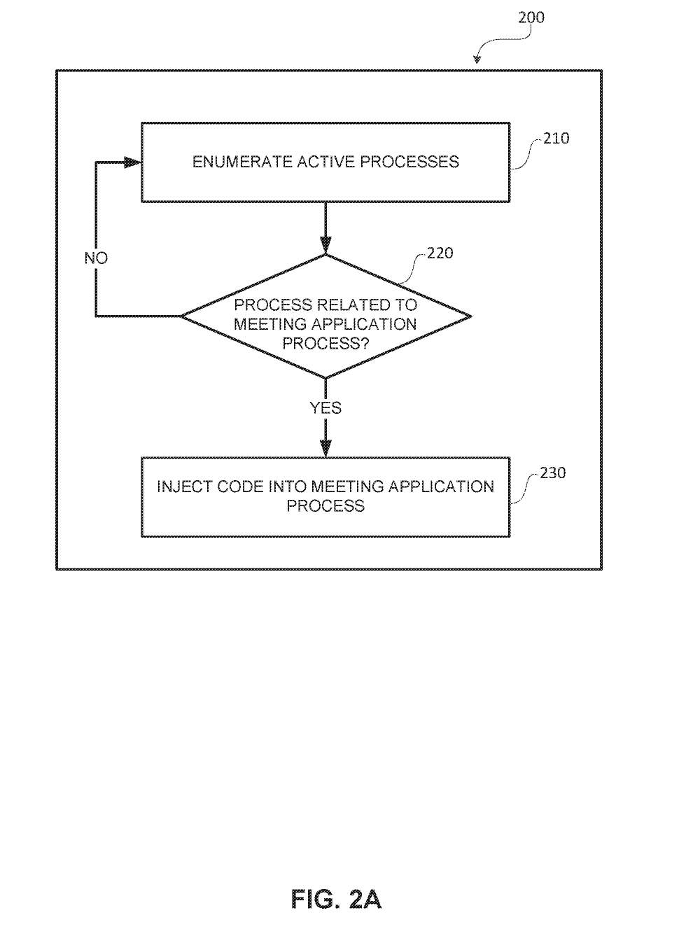

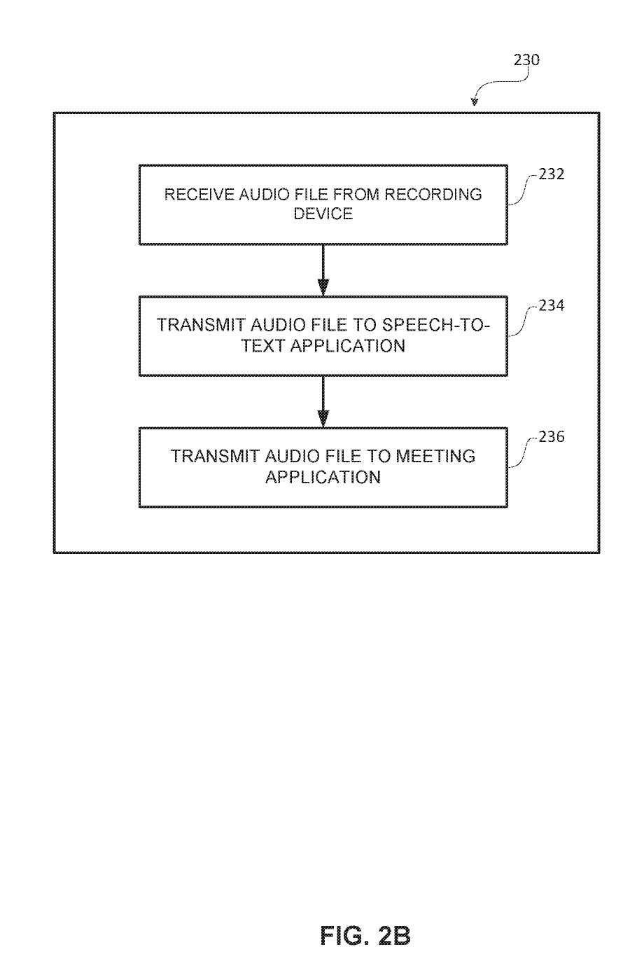

FIGS. 2A and 2B illustrate a flowchart illustrating an example process 200 for extracting contents of meetings from a meeting application according to example aspects of the subject technology.

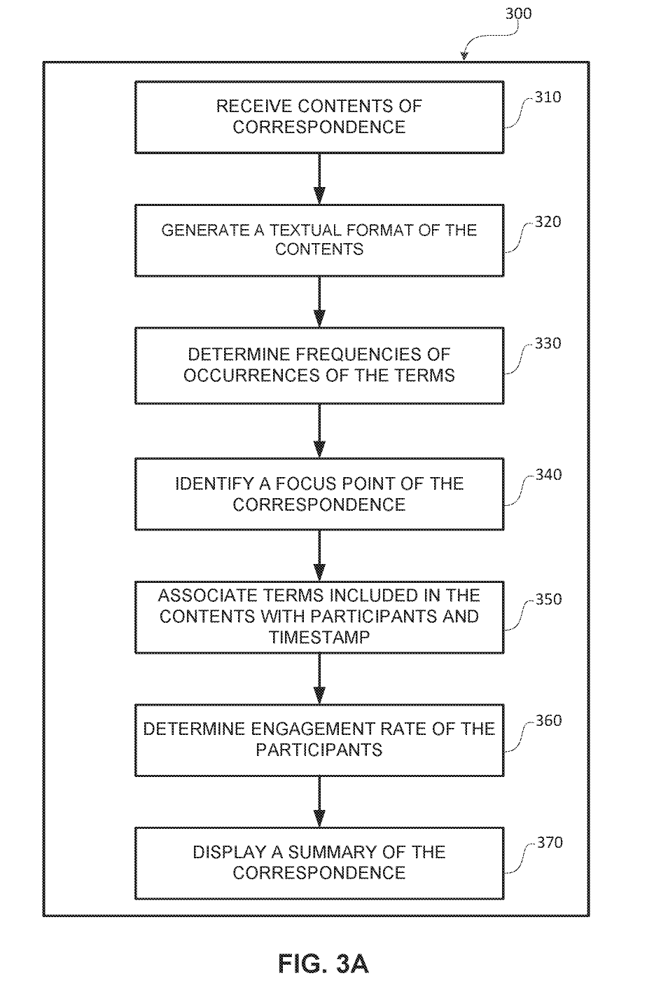

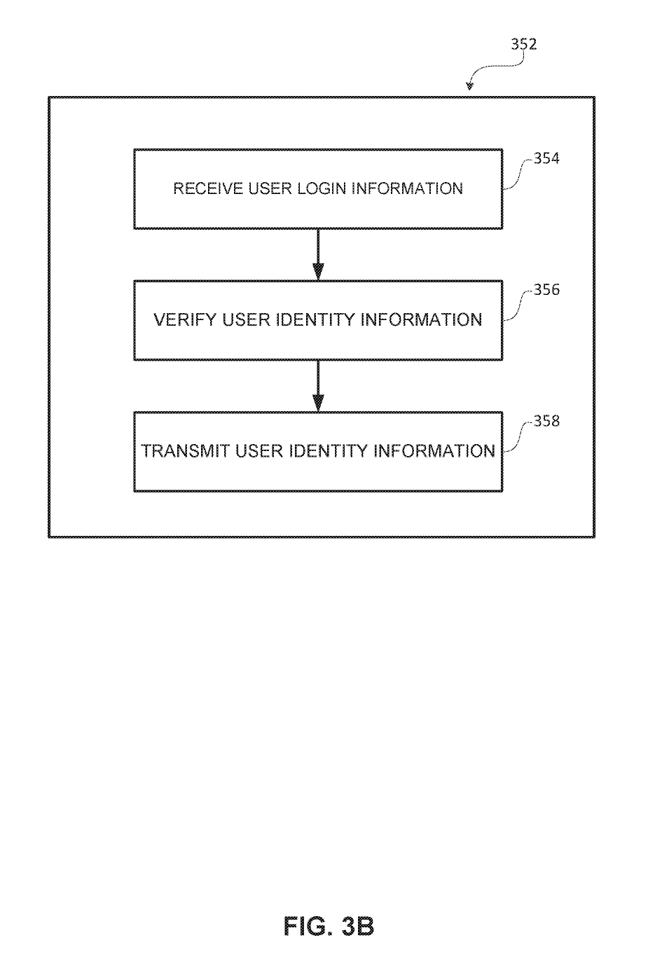

FIGS. 3A and 3B illustrate a flowchart illustrating an example process 300 for annotating and aggregating meetings according to example aspects of the subject technology.

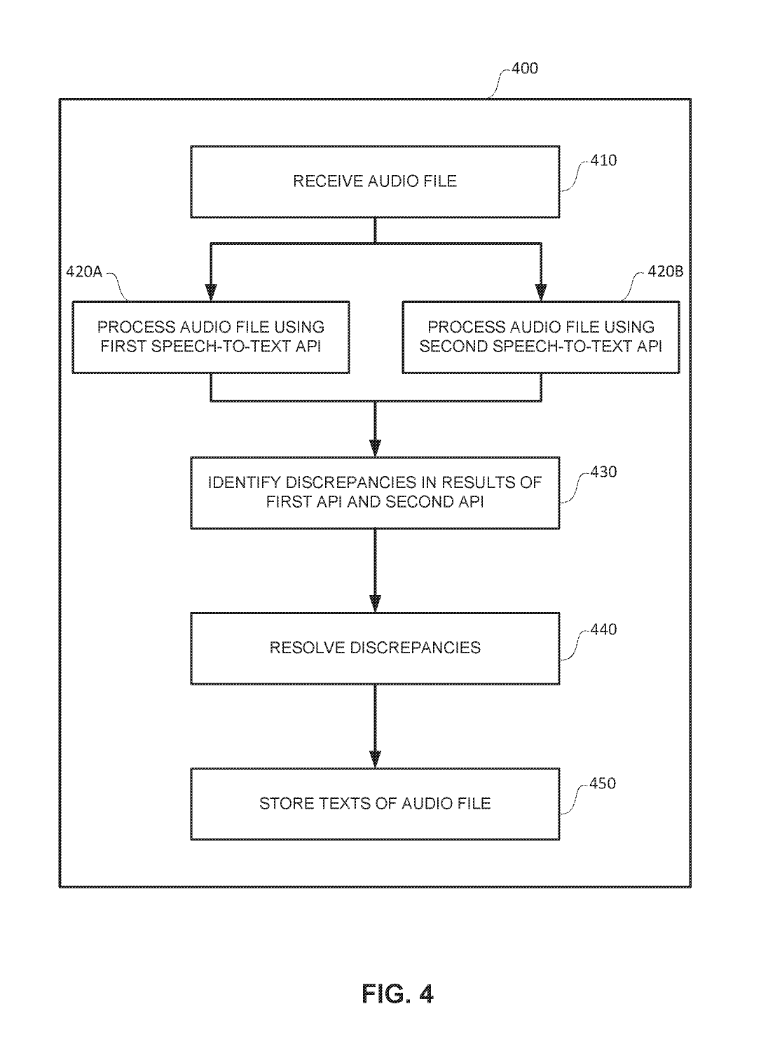

FIG. 4 illustrates a flowchart illustrating an example process 400 for extracting contents of meetings from meeting application according to example aspects of the subject technology.

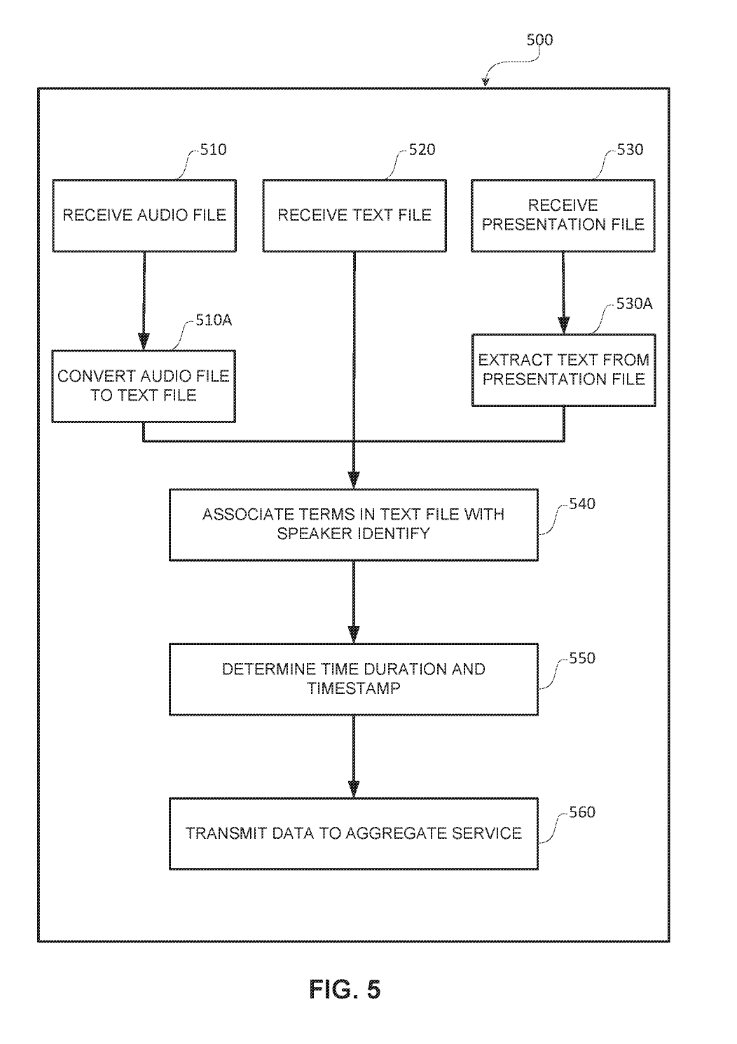

FIG. 5 illustrates a flowchart illustrating an example process 500 for annotating and aggregating contents of meeting according to example aspects of the subject technology.

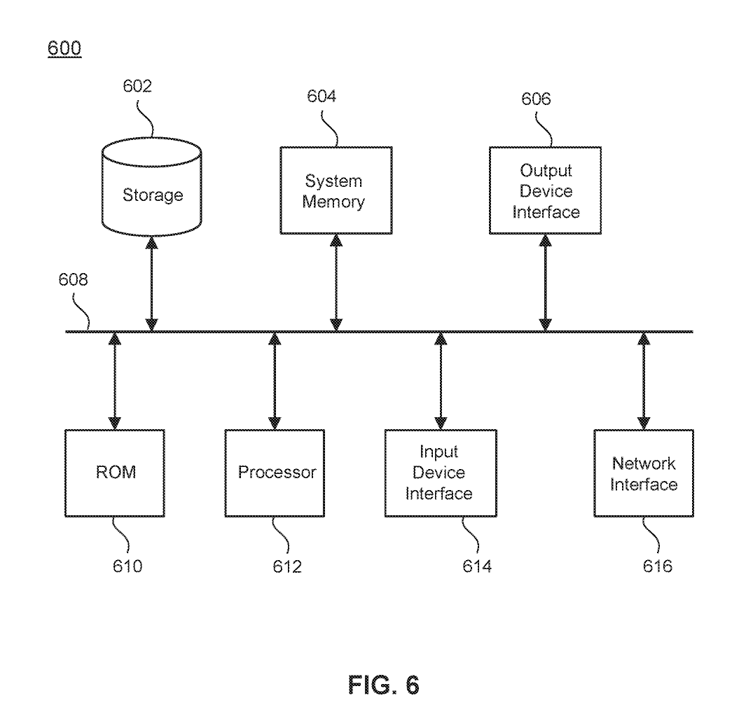

FIG. 6 conceptually illustrates an example electronic system 600 with which some implementations of the subject technology can be implemented

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description may include specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

The subject technology provides systems and methods for annotating and visualizing contents of meetings. Often times, a participant of a meeting is assigned a role of a note taker acting predominately as a passive participant and a scribe. This may be an inefficient use of time and may introduce personal bias as not all the information discussed in the meeting are accurately recorded. The subject technology provides systems and methods for tracking meetings, annotating contents of meetings, analyzing the annotated contents of the meetings, and visualizing trends in an organization based on the analysis.

Further, all meetings held in the entity may be recorded and aggregated according to the subject technology across a plurality of communication applications. For example, the subject technology provides for management team of the entity to gain visibility into how the employees are spending their time: who is contributing most during meetings, who is attending the most meetings, and what types of meetings are taking up the most amount of time from a resource allocation perspective.

FIG. 1 illustrates an example network environment 100 for creating and managing electronic calendar events in accordance with the subject technology. The network environment 100 includes computing devices 102, 104, and 106, a recording device 108, and servers 110 and 114. In some aspects, the network environment 100 can have more or fewer computing devices (e.g., 102-106), microphone (e.g., 108), and/or servers (e.g., 110 and 114) than those shown in FIG. 1.

Each of the computing devices 102, 104, and 106 and a recording device 108 can represent various forms of processing devices that have a processor, a memory, and communications capability. The computing devices 102, 104, and 106 and the recording device 108 may communicate with each other, with the servers 110 and 114, and/or with other systems and devices not shown in FIG. 1. By way of non-limiting example, processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any of these processing devices or other processing devices.

Each of the computing devices 102, 104, and 106 and the recording device 108 may be provided with one or more meeting software applications. The computing devices 102, 104, and 106 and the recording device 108 may execute computer instructions to run the meeting software applications. The users of the respective computing devices may utilize the meeting software applications to communicate with each other and/or with users who are not depicted in FIG. 1. The meeting software applications may transmit and receive text files and audio files to server 110 (e.g., annotation system) via network 118. The annotation system may transmit data corresponding to the annotation result of the content of the meeting to server 114 (e.g., aggregation system) via network 118. In some aspects, the meeting software applications may include annotation capability. In such a case, each of the computing devices 102, 104, and 106 and the recording device 108 may communicate with the server 114 via the network 118 to provide the annotation result of the contents of the meeting.

The network 108 can be a computer network such as, for example, a local area network (LAN), wide area network (WAN), the Internet, a cellular network, or a combination thereof connecting any number of mobile clients, fixed clients, and servers. Further, the network 108 can include, but is not limited to, any one or more of the following network topologies, including a bus network, a star network, a ring network, a mesh network, a star-bus network, tree or hierarchical network, and the like. In some aspects, communication between each client (e.g., computing devices 102, 104, and 106) and server (e.g., server 110) can occur via a virtual private network (VPN), Secure Shell (SSH) tunnel, Secure Socket Layer (SSL) communication, or other secure network connection. In some aspects, network 108 may further include a corporate network (e.g., intranet) and one or more wireless access points.

Each of the servers 110 and 114 may represent a single computing device such as a computer server that includes a processor and a memory. The processor may execute computer instructions stored in memory. The servers 110 and 114 may be geographically collocated and/or the servers 110 and 114 may be disparately located. In some aspects, the servers 110 and 114 may collectively represent a computer server. In some aspects, the servers 110 and 114 may each be implemented using multiple distributed computing devices. The servers 110 and 114 are configured to communicate with client applications (e.g., electronic messaging applications, calendar applications, etc.) on client devices (e.g., the computing devices 102, 104, and 106) via the network 118.

The server 110 may be an annotation system (e.g., voice-to-text, etc.) that manages message exchanges (e.g., text format or audio format) between participants of the meeting. The server 110 may include a data store 112 for storing, for example, an n-gram database. For example, when the contents of a meeting include a jargon-heavy discussion, one or more voice-to-text algorithms may be invoked simultaneously and the results are aggregated by searching through the n-gram database to find likely pairs of words. In some aspects, the data store 112 may store, for example, a local dictionary. For example, entities may assign a local dictionary to aid translating meaning for common terms to an industry specific meaning. The annotation system produces a textual output of audio files of the contents of the meetings using, for example, natural language processing.

The server 114 may be an aggregation system that analyzes the textual output received from the annotation system (e.g., server 110). The aggregation system may allow the textual representations of the contents of the meeting to be further analyzed. The server 114 may include a data store 116 for storing, for example, participant information and hardware information of the computing devices and the recording device used during the meeting.

A textual output may be associated with a unique identifier for a computing device or a recording device based on the hardware information. Further, a participant's unique user identifier is associated to the textual output based on a name of a speaker provided for display by the meeting software applications. In some aspects, a participant may be identified based on voice recognition. Furthermore, a timestamp may be associated with the textual output. In some aspects, an association may be made with the user identifier, the device identifier, and the timestamp.

In some aspects, textual outputs are analyzed to establish a chronology of introduced concepts and for plotting the development of an idea by parsing each textual phrase, isolating sequence of one of more terms, and storing a timestamp of when each sequence occurs. For example, new n-grams may be identified when analyzing the textual output, and the aggregation system may update n-grams stored in the data store of the server 110 when a predetermined number of occurrences of a particular new n-gram are observed. A counter associated with each isolated sequence of the terms in the textual output is incremented. The frequency of the occurrences of the sequences across textual output of the contents of the meeting is determined based on the counter and the timestamp.

Contribution of each of the participants of the meeting is determined based on the frequency of appearance of the user identifier or device identifier. When a request is received, the aggregation system may generate a graphical representation of contribution of each individual. The aggregation system may also alert an administrator when a new concept is detected during the analysis of the textual output. The aggregation system may alert the administrator by providing visual and/or audio notifications for display and/or for audio.

In some aspects, the aggregation system may be integrated with the annotation system. In some aspects, the annotation system may also be included in the meeting software applications. In one or more implementations, the computing device 102, the computing device 104, the computing device 106, the recording device 108, the server 110, or the server 114 may be, or may include all or part of, the electronic system components that are discussed below with respect to FIG. 6.

FIGS. 2A and 2B show a flowchart illustrating an example process 200 for extracting contents of meetings from a meeting application according to example aspects of the subject technology. In one example, the various blocks of example process 200 are described herein with reference to the components and/or processes described herein. The one or more of the blocks of process 200 may be implemented, for example, by one or more components or processors of server 110 and/or server 114 of FIG. 1. In some implementations, one or more of the blocks may be implemented apart from other blocks, and by one or more different processors or controllers. In one example, the blocks of example process 200 are described as occurring in serial, or linearly. However, multiple blocks of example process 200 may occur in parallel. In addition, the blocks of example process 200 need not be performed in the order shown and/or one or more of the blocks of example process 200 need not be performed.

Meetings may be in-person face-to-face meetings. In some aspects, meetings may be virtual meetings conducted through meeting applications in which the participants of the meetings correspond with one another via a telephone line, a video stream, or messaging application. In some other aspects, meetings may include email exchanges. Meetings may also include slide presentations shared, for example via web browsers.

At block 210 of FIG. 2A, processes on client devices (e.g., computing devices 102, 104, 106 and recording device 108) are enumerated. The processes may include any processes performed by applications and operating systems of the client device. At block 220, it is determined whether a process in the enumerated processes is related to a meeting application process. When the process is related to the meeting application process (Block 220=YES), process 200 proceeds to block 230 in which codes for extracting contents (e.g., audio data, text data, presentation data) of a meeting are injected in the meeting application process. On the other hand, when the process in the enumerated processes does not concern a meeting application process (Block 220=NO), process 200 returns to block 210.

Referring to process 230 in FIG. 2B, when audio data is received from a recording mechanism of computing device (e.g., microphone on computing devices 102, 104, 106) or recording device (e.g., standalone microphone, telephone) during a meeting at block 232, process 230 proceeds to block 234 in which the audio data is transmitted to a speech-to-text application. The audio data may be transmitted in response to an application programming interface (API) request of the codes included in the meeting application. At block 236, the audio file is also transmitted to the meeting application. In some aspects, block 234 and block 236 may be performed in parallel.

FIGS. 3A and 3B show a flowchart illustrating an example process 300 for annotating and aggregating meetings according to example aspects of the subject technology. In one example, the various blocks of example process 300 are described herein with reference to the components and/or processes described herein. The one or more of the blocks of process 300 may be implemented, for example, by one or more components or processors of server 110 and/or server 114 of FIG. 1. In some implementations, one or more of the blocks may be implemented apart from other blocks, and by one or more different processors or controllers. Further In one example, the blocks of example process 300 are described as occurring in serial, or linearly. However, multiple blocks of example process 300 may occur in parallel. In addition, the blocks of example process 300 need not be performed in the order shown and/or one or more of the blocks of example process 300 need not be performed.

At block 310 of FIG. 3A, an annotation system receives contents of correspondence (e.g., meeting, telephone conversation, text messaging, etc.). The annotation system may receive the contents of correspondence. The contents of correspondence may be audio data received via a recording device. In some aspects, the contents of correspondence may be text data exchanged among participants of a meeting via a messaging application (e.g., instant messaging application, chat application, email application). In some other aspects, the contents of correspondence may be presentation data of any visual presentation (e.g., slide presentation, document file, images) shared during a meeting.

At block 320, the annotation system generates textual format of the contents of correspondence. For example, a speech-to-text process is performed on the received audio data to generate the textual format of the contents. The speech-to-text process is described in detail with respect to FIG. 4. In some aspects, an optical character recognition (OCR) process may be performed on the received presentation data to generate textual format of the contents.

At block 330, the annotation system determines frequencies of occurrences of the terms included in the textual format of the contents. The annotation system may store in the data store (e.g., data store 112) a table including the terms from the textual format of the correspondence. In some aspects, the annotation system may maintain an accumulative table of terms from previous correspondence. The table may also include a counter for each of the terms. For example, the annotation system increments the counter for a term when the term appears in the contents of correspondence. The annotation system may determine the frequencies of occurrences of the terms based on the counters.

At block 340, the annotation system identifies a focus point of the correspondence based on the terms used and the frequencies of the occurrences of the terms during the correspondence. For example, when terms “next week,” “training,” and “new hire” have higher frequencies of occurrences than other terms in the correspondence, the annotation system may identify as the focus point of the meeting as “new hire training next week.”

At block 350, the annotation system associates the terms included in the contents with user identity information of participants and timestamps based on the contents of correspondence. For example, the contents of correspondence may include the information regarding from which participant the term came and may also include timestamp for when each of the terms occurred.

Referring to process 352 of FIG. 3B, user information of participants of the correspondence is received at block 354. For example, the user information may be obtained through user login information of the client device. In some other aspects, user information displayed on a user interface of a meeting application. For example, the displayed user interface may be sent to the annotation system as a part of the presentation data. The annotation system may perform an OCR process on the user interface to obtain user information of participants. At block 356 of FIG. 3B, user identity information of participants are verified by looking up the user information on an Active Directory or an organization chart of an entity. In some aspects, the user identity information may include a name or a role in the entity. At block 358, the user identity information is transmitted to the annotation system.

Returning to FIG. 3A, at block 360, the annotation system determines an engagement rate of the participants based on the focus point and the association of the terms and participants and timestamps. For example, the annotation system determines that a participant who spoke or typed a number of times and his/her statement included the terms associated with the focus point above a predetermined threshold would have a higher engagement rate. On the other hand, a participant who did not speak or spoke fewer times than the other participants during the correspondence would have a lower engagement rate.

At block 370, an aggregation system provides a summary of the correspondence based on the information retrieved from the annotation system. For example, the summary may include a list of terms based on the number of frequencies of occurrence. In some aspects, the summary may include a report of engagement or involvement of the participants. The summary may also be interactive such that the user interface may allow an operator to display the desired information.

FIG. 4 shows a flowchart illustrating an example process 400 for extracting contents of meetings from a meeting application according to example aspects of the subject technology. In one example, the various blocks of example process 400 are described herein with reference to the components and/or processes described herein. The one or more of the blocks of process 400 may be implemented, for example, by one or more components or processors of server 110 and/or server 114 of FIG. 1. In some implementations, one or more of the blocks may be implemented apart from other blocks, and by one or more different processors or controllers. Further In one example, the blocks of example process 400 are described as occurring in serial, or linearly. However, multiple blocks of example process 400 may occur in parallel. In addition, the blocks of example process 400 need not be performed in the order shown and/or one or more of the blocks of example process 400 need not be performed.

At block 410, the annotation system receives audio file as a part of the contents of correspondence. Audio may be retrieved by a microphone on a computing device, a standalone microphone, and/or other recording devices. The audio file received from the recording devices may be raw audio files. At block 420A, the annotation system processes the audio file using a first speech-to-text application to convert the raw audio file to text files (e.g., textual format of the contents of correspondence). In parallel to block 420A, at block 420B, the annotation system processes the audio file using a second speech-to-text application. In some aspects, the first speech-to-text application and the second speech-to-text application may be different types of speech-to-text applications. In some other aspects, the first speech-to-text application and the second speech-to-text application may be the same type of speech-to-text application. The audio file may be processed multiple times by the same speech-to-text application.

At block 430, the annotation system identifies discrepancies in the text results of the first speech-to-text application and the second speech-to-text application by comparing the results. The annotation system may compare term by term in the results of the first speech-to-text application and the second speech-to-text application. When any one of the terms in either result differs from the other results, the process proceeds to block 440 in which the discrepancies are resolved.

At block 440, the annotation system resolves the identified discrepancies. When discrepancies are identified, the annotation system refers to a dictionary stored in a data store. The dictionary may be an entity specific dictionary. For example, the dictionary may be a table stored in a data store. The table may include field-specific jargons. At block 450, the annotation system stores the text file of the audio file after the discrepancies are resolved.

FIG. 5 shows a flowchart illustrating an example process 500 for annotating and aggregating contents of correspondence (e.g., meeting) according to example aspects of the subject technology. In one example, the various blocks of example process 500 are described herein with reference to the components and/or processes described herein. The one or more of the blocks of process 500 may be implemented, for example, by one or more components or processors of server 110 and/or server 114 of FIG. 1. In some implementations, one or more of the blocks may be implemented apart from other blocks, and by one or more different processors or controllers. Further In one example, the blocks of example process 500 are described as occurring in serial or linearly. However, multiple blocks of example process 500 may occur in parallel. In addition, the blocks of example process 500 need not be performed in the order shown and/or one or more of the blocks of example process 500 need not be performed.

At block 510, the annotation system receives an audio file of the contents of correspondence. The audio files may include audio feed from a telephone, microphones, and the like. At block 510A, the annotation system converts the audio file to a text file according to the methods described in FIG. 4. At block 520, the annotation system receives a text file of the contents of correspondence. The text files may include text messages exchanged over a messaging application, email application, and the like during the meeting. At block 530, the annotation system receives a presentation file which includes slides, images, and the like shared during the meeting. At block 530A, the annotation system extracts texts from the presentation file. For example, the annotation system may use an OCR process to extract and convert texts from the presentation file.

At block 540, the annotation system associates terms in the text file with the identity of the speaker who made a statement including the term. The speaker may be a person who typed when the term's source is a text file, and may be a presenter when the term's source is a presentation file. As described above, the identity of the speaker may be identified based on the information included in the contents of correspondence, or based on the information determined based on the user identity information included in the received files.

At block 550, the annotation system determines time duration and timestamp. For example, the annotation system determines the time duration of the meeting based on the start and end of the meeting session on the meeting application. In some aspects, the time duration may be based on when the first audio file, text file, or presentation file was received. The annotation system also determines timestamp for each of the audio file, text file, and/or presentation file.

At block 560, the annotation system transmits data of the contents of the meeting to the aggregate system. For example, the data includes the text file of the raw data (e.g., audio file, text file, and presentation file), the association information related to the user identity, and the determination information of the time duration and timestamps. The aggregate system generates a summary of the meeting based on the transmitted data.

The disclosed technology provides retrofitting to existing structures. In some aspects, a unique feature of the subject technology is that the annotation application with the features of the subject technology sits at a layer above that allows disparate meeting applications or chat applications to work together. The aggregation system may be of a configuration (Apache, IIS, etc.) which receives a POST request with all of the parameters, including the extracted text and user identity information. All of the aggregated data is used and data-mined automatically based on the subject technology. Concepts are extracted using natural language processing to identify important text and keywords being used across the entity. New ideas are automatically timestamped and marked to allow for strong defense of intellectual property. In some aspects, as data is received from the annotation system, the aggregation system may index the terms and the related information to track the progression and development of a concept. For example, the first time that “Flying Car” is mentioned in the entity is noted and the later mentions of that concept are stored as related entries.

For example, as data flows in, the management team can identify important concepts which are beginning to be used more regularly throughout the entity. For example, if a particular bug in a software application produces “Error 123”, customer support calls where users mention “Error 123” will be indexed automatically, so that a product management team can be alerted after a predetermined number of mentions across the customer support calls. Accordingly, the error can be escalated and given attention as needed in a timely manner.

While the error is being investigated, the product management team may also be presented with which employees are being tasked with working on resolution of the error based on what meetings are created and which employees are referring to the error during the meeting. This simplifies resource management and ensures that high priority issues are taken care of efficiently.

In some aspects, for example, during a daily stand-up meeting, engineers discuss an idea to improve efficiency by replacing “Component X” with a new design, “Design Y.” Every mention of “Design Y” can be automatically attributed and correlated using the subject technology, giving a historical view into the development of the idea, who was involved, and what needs to be covered from an Intellectual Property perspective. Insight into the quantity of resources being devoted to particular concepts and how much effort is spent discussing particular features may also be readily available for the management team.

FIG. 6 conceptually illustrates an example electronic system 600 with which some implementations of the subject technology can be implemented. Electronic system 600 can be a computer, phone, personal digital assistant (PDA), or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 502, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (for example, a magnetic or optical disk, or flash memory) as permanent storage device 602.

Other implementations use a removable storage device (for example, a floppy disk, flash drive) as permanent storage device 602. Like permanent storage device 602, system memory 604 is a read-and-write memory device. However, unlike storage device 602, system memory 604 is a volatile read-and-write memory, such as a random access memory. System memory 604 stores some of the instructions and data that the processor needs at runtime. In some implementations, the processes of the subject disclosure are stored in system memory 604, permanent storage device 602, or ROM 610. For example, the various memory units include instructions for displaying graphical elements and identifiers associated with respective applications, receiving a predetermined user input to display visual representations of shortcuts associated with respective applications, and displaying the visual representations of shortcuts. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interfaces 606 enables, for example, the display of images generated by the electronic system 600. Output devices used with output device interface 606 include, for example, printers and display devices, for example, cathode ray tubes (CRT) or liquid crystal displays (LCD). Some implementations include devices, for example, a touchscreen, that function as both input and output devices.

Finally, as shown in FIG. 6, bus 608 also couples electronic system 600 to a network (not shown) through a network interface 616. In this manner, the computer can be a part of a network of computers (for example, a LAN, a WAN, or an Intranet, or a network of networks, for example, the Internet). Any or all components of electronic system 600 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, magnetic media, optical media, electronic media, etc. The computer readable media does not include carrier waves and electronic signals passing wirelessly or over wired connections.

In this specification, the term “software” is meant to include, for example, firmware residing in read-only memory or other form of electronic storage, or applications that may be stored in magnetic storage, optical, solid state, etc., which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks

Some implementations include electronic components, for example, microprocessors, storage, and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra-density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

All structural and functional equivalents to the elements of the various aspects described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include”, “have”, or the like is used in the description or the claims, such term is intended to be inclusive in a manner similar to the term “comprise” as “comprise” is interpreted when employed as a transitional word in a claim.

What is claimed is:

1. A computer-implemented method, comprising:
receiving contents of a meeting, the contents comprising at least one of audio data, text data, and presentation data;
generating a textual format of the contents of the meeting;
determining frequencies of occurrences for terms included in the textual format of the contents;
determining a trending term based on the frequencies of occurrences;
associating terms included in the textual format of the contents with participants of the meeting and timestamps;
determining an engagement rate of each of the participants of the meeting based on the determined frequencies of occurrences and the association of the terms with the participants of the meeting and the timestamps; and
displaying a summary of the meeting, wherein the summary comprises the trending term, the engagement rate for each of the participants of the meeting, and a time duration over which the meeting occurred.

2. The computer-implemented method of claim 1, further comprising:
displaying a notification when one or more terms of the terms included in the textual format are identified as satisfying a threshold frequency of occurrences.

3. The computer-implemented method of claim 1, further comprising:
identifying a focus point of the meeting based on the determined frequencies of occurrences for the terms.

4. The computer-implemented method of claim 3, wherein the focus point is determined based on a set of terms that satisfies predetermined frequencies of occurrences.

5. The computer-implemented method of claim 4, wherein the engagement rate increases when the participant is associated with the set of terms that satisfies predetermined frequencies of occurrences.

6. The computer-implemented method of claim 1, wherein the trending term is a first term having a highest frequency of occurrences.

7. The computer-implemented method of claim 6, wherein the trending term is further determined based on the frequencies of occurrences over a predetermined period of time.

8. A system comprising:
one or more processors;
a non-transitory computer-readable storage medium coupled to the one or more processors, the non-transitory computer-readable storage medium including instructions that, when executed by the one or more processors, cause the one or more processors to:
receive contents of a correspondence, the contents comprising at least one of audio data, text data, and presentation data;
generate a textual format of the contents of the correspondence;
associate terms included in the textual format of the contents with participants of the correspondence and timestamps;
determine an engagement rate of each of the participants of the correspondence based on associating the terms with the participants and the timestamps;
determine frequencies of occurrences for the terms included in the textual format of the contents;
identify a focus point of the correspondence based on the determined frequencies of occurrences for the terms; and
provide for display a summary of the correspondence, wherein the summary comprises the focus point of the correspondence, the engagement rate for each of the participants of the correspondence, and a time duration over which the correspondence occurs.

9. The system of claim 8, further comprising providing for display a notification when one or more terms of the terms included in the textual format are identified as satisfying a threshold frequency of occurrences.

10. The system of claim 8, further comprising determining a trending term based on the frequencies of occurrences.

11. The system of claim 10, wherein the trending term is a first term having a highest frequency of occurrences.

12. The system of claim 11, wherein the trending term is further determined based on the frequencies of occurrences over a predetermined period of time

13. The system of claim 8, wherein the focus point is determined based on a set of terms that satisfies predetermined frequencies of occurrences.

14. The system of claim 13, wherein the engagement rate increases when the participant is associated with the set of terms that satisfies predetermined frequencies of occurrences.

15. A non-transitory computer-readable medium comprising instructions stored therein, which when executed by a processor, cause the computer to perform operations comprising:
receiving contents of a correspondence, the contents comprising at least one of audio data, text data, and presentation data;
generating a textual format of the contents of the correspondence;
associating terms included in the textual format of the contents with participants of the correspondence and timestamps;
determining an engagement rate of each of the participants of the correspondence based on associating the terms with the participants and the timestamps;
determining frequencies of occurrences for the terms included in the textual format of the contents;
identifying a focus point of the correspondence based on the determined frequencies of occurrences for the terms; and
providing for display a summary of the correspondence, wherein the summary comprises the focus point of the correspondence, the engagement rate for each of the participants of the correspondence, and a time duration over which the correspondence occur.

16. The non-transitory computer-readable medium of claim 15, wherein the operations further comprise:
providing for display a notification when one or more terms of the terms included in the textual format are identified as satisfying a threshold frequency of occurrences.

17. The non-transitory computer-readable medium of claim 15, wherein the focus point is determined based on a set of terms that satisfies predetermined frequencies of occurrences.

18. The non-transitory computer-readable storage medium of claim 17, wherein the engagement rate increases when the participant is associated with the set of terms that satisfies predetermined frequencies of occurrences.

19. The non-transitory computer-readable storage medium of claim 15, wherein the operations further comprise:
determining a trending term based on the frequencies of occurrences.

20. The non-transitory computer-readable storage medium of claim 19, wherein the trending term is a first term having a highest frequency of occurrences, and wherein the trending term is further determined based on the frequencies of occurrences over a predetermined period of time.
